(19) United States
(12) Patent Application Publication
(10) Pub. No.: US 2026/0057700 A1
(43) Pub. Date: Feb. 26, 2026

(54) ARTIFICIAL INTELLIGENCE DRIVEN INVENTORY, SERVICE, HOSPITALITY AND PERSONNEL MANAGEMENT SYSTEM FOR DRINKING, FOOD SERVICE, HOSPITALITY, CASINO, AND OTHER RETAIL ESTABLISHMENTS

(71) Applicant: Terrence LEE, Fort Lauderdale, FL (US)

(72) Inventor: Terrence LEE, Fort Lauderdale, FL (US)

(21) Appl. No.: 18/813,946

(22) Filed: Aug. 23, 2024

(51) Int. Cl. G06V 40/20; G06Q 20/20; G06V 20/68

(52) U.S. Cl. CPC G06V 40/20; G06Q 20/20; G06V 20/68

(57) ABSTRACT

A data processing system implements obtaining invoice information from a point-of-sale system identifying drinks ordered from a bar; obtaining video content from a video monitoring system that captures a bartender as the bartender is making drinks; analyzing the invoice information and the video content using a multimodal model trained to identify discrepancies between the drinks made by the bartender and the drinks ordered, the multimodal model being trained to output incident information identifying the bartender who made the drinks, ingredients used to make the drinks, and discrepancies between the drinks made by the bartender and the drinks ordered; generating one or more alerts to one or more members of staff identifying the discrepancies between the drinks made and the drinks ordered; and sending the one or more alerts to one or more network-enabled computing devices of the one or more members of staff of the bar.

### BACKGROUND

Managing personnel, operations, and inventory in drinking, food service, and retail establishments is critical to ensure the success of such establishments. Training and monitoring personnel to properly interact with and serve customers is also critical for ensuring customers have an enjoyable experience at a drinking or food service establishment. Furthermore, training personnel to properly utilize inventory is important for avoiding waste. To illustrate this point, bars are an important source of revenue for many drinking and food service establishments, and overpours by bartenders can significantly impact the profitability of the establishment. An overpour occurs when a bartender pours more alcohol into a drink than was ordered or than is standard for the size of the drink. Overpours lead to unnecessary waste and decreased revenue for the establishment. Overpouring may be intentional to elicit a larger tip or to provide extra product to certain customers. Overpouring may also be unintentional due to a lack of proper measuring tools or a lack of proper training. Similarly, bartenders may provide free drinks to customers or upgrade basic drinks to premium drinks without charging the customers for such upgrades. All of these actions can result in significant loss of revenue to the drinking and food service establishments. Hence, there is a need for improved systems and methods that provide a technical solution for implementing automated methods for detecting such actions that cause losses in revenue and alerting management so that action can be taken to avoid these actions.

### SUMMARY

An example data processing system according to the disclosure may include a processor and a machine-readable medium storing executable instructions. The instructions when executed cause the processor alone or in combination with other processors to perform operations including obtaining, via a data interface unit, invoice information from a point-of-sale (POS) system, the invoice information identifying drinks ordered from a bar; obtaining, via the data interface unit, video content from a video monitoring system that captures a bartender as the bartender is making drinks, the video content comprising one or more video streams captured by one or more cameras disposed throughout the bar; analyzing the invoice information and the video content using a multimodal model trained to identify discrepancies between the drinks made by the bartender and the drinks ordered, the multimodal model being trained to output incident information discrepancies between the drinks made by the bartender and the drinks ordered; generating one or more alerts to one or more members of staff using an alert and report generation unit, each alert identifying the discrepancies between the drinks made and the drinks ordered; and sending, using the alert and report generation unit, the one or more alerts to one or more network-enabled computing devices of the one or more members of staff of the bar.

An example method implemented in a data processing system includes obtaining, via a data interface unit, invoice information from a point-of-sale (POS) system, the invoice information identifying drinks ordered from a bar; obtaining, via the data interface unit, video content from a video monitoring system that captures a bartender as the bartender is making drinks, the video content comprising one or more video streams captured by one or more cameras disposed throughout the bar; analyzing the invoice information and the video content using a multimodal model trained to identify discrepancies between the drinks made by the bartender and the drinks ordered, the multimodal model being trained to output incident information discrepancies between the drinks made by the bartender and the drinks ordered; generating one or more alerts to one or more members of staff using an alert and report generation unit, each alert identifying the discrepancies between the drinks made and the drinks ordered; and sending, using the alert and report generation unit, the one or more alerts to one or more network-enabled computing devices of the one or more members of staff of the bar.

An example data processing system according to the disclosure may include a processor and a machine-readable medium storing executable instructions. The instructions when executed cause the processor alone or in combination with other processors to perform operations including obtaining a video stream from a video monitoring system that captures video content of a bartender using one or more cameras as the bartender is operating a bar; analyzing the video stream as the video stream is received from the video monitoring system using a video analysis model trained to monitor performance of the bartender operating the bar and to output performance information indicative of the performance of the bartender during the video stream; analyzing the performance information as the performance information is output by the video analysis model to generate performance alerts; and sending the performance alerts to a computing device of a manager as the bartender is operating the bar.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment in which the techniques disclosed herein for inventory and personnel management are implemented.

FIG. 2 is a diagram showing an example layout of a restaurant in which the techniques herein have been implemented shown in FIG. 1.

FIGS. 3A and 3B are diagrams of an example user interface of an alerts and reporting application according to the techniques disclosed herein.

FIG. 4 is a diagram providing additional examples of an alerts and reporting application according to the techniques herein.

FIG. 5 is an example flow chart of an example process for managing inventory and personnel according to the techniques described herein.

FIG. 6 is an example flow chart of another example process for managing inventory and personnel according to the techniques described herein.

FIG. 7 is a block diagram showing an example software architecture, various portions of which may be used in conjunction with various hardware architectures herein described, which may implement any of the described features.

FIG. 8 is a block diagram showing components of an example machine configured to read instructions from a machine-readable medium and perform any of the features described herein.

### DETAILED DESCRIPTION

Techniques for artificial intelligence (AI) driven inventory and personnel management are provided herein. These techniques provide a technical solution to the technical problems associated with automatically identifying inventory and personnel management issues associated with a food service or drinking establishment that can cause losses in revenue. The technical solution includes an inventory and personnel management platform that integrates with a video monitoring system and point of sale (POS) system of an establishment in which the platform analyzes the video content obtained from the video monitoring system and takes various actions in response to issues detected in the video content in real time. The inventory and personnel management platform analyzes video content captured by one or more cameras that monitor the activities of a bartender as the bartender operates the bar. The inventory and personnel management platform utilizes a video analysis model to analyze video streams of the bartender in substantially real time and invoice information obtained from the POS system to detect discrepancies between drinks ordered via the inventory management system and the drinks prepared by the bartender. The video analysis model is trained to identify the types of spirits that may be dispensed by the bartender in the video content, to determine how much of the spirits are being poured by the bartender, and to correlate that information with recipe information that indicates how each of the invoiced drinks should be made. The video analysis model can also identify drinks that were prepared by the bartender that were not invoiced and/or waste caused by spillage. The video analysis model outputs discrepancy information that identifies discrepancies between the drinks prepared by the bartender and the drinks that were invoiced in the POS system. The discrepancy information can include a brand name or other identifier of the spirit or spirits that should have been included in the drink prepared by the bartender, the brand name or other identifier of the spirts or spirits that were actually included in the drink, the other ingredients included in the drink that were not included in the recipe for the drink and/or ingredients omitted from the drink that were included in the recipe. The inventory and personnel management platform analyzes this discrepancy information and alerts a manager of the establishment in substantially real time as these events are occurring. A technical benefit of this approach is that potential losses of revenue can be addressed in substantially real time while the bartender is on duty to avoid further loss of revenue. Furthermore, the inventory and personnel management platform can also develop a remedial training plan for the bartender based on the noted discrepancies to help train the employee to avoid such actions in the future that result in loss of revenue for the establishment. The inventory and personnel management platform also tracks inventory items utilized. The inventory and personnel management platform facilitates reordering inventory items for which the stock has fallen below a reordering threshold, which is configurable for each inventory item and/or type of inventory item. The inventory and personnel management platform can also track maintenance and/or sanitation issues that can create an unsafe and/or unhealthy environment for staff and/or customers. These sanitation issues can include but are not limited to failure regularly empty trash receptacles, failure to adequately wash glassware and/or other serveware, failure to adequately sanitize surfaces in the bar area, and/or failure to remove dirty glasses and/or other serveware from the bar and/or customer tables within a threshold period of time. These maintenance issues can include but are not limited to broken or insufficient lighting, broken or damaged fixtures or furniture, broken or unavailable sanitation stations for the bartender and/or other staff to wash their hands, and/or other maintenance issues that can cause a safety hazard for the bartender, other staff, and/or customers. A technical benefit of this approach is that health and safety issues can be identified in substantially real time and an alert generated to alert a manager and/or other staff members to address these issues as they arise. These and other technical benefits of the techniques disclosed herein will be evident from the discussion of the example implementations that follow.

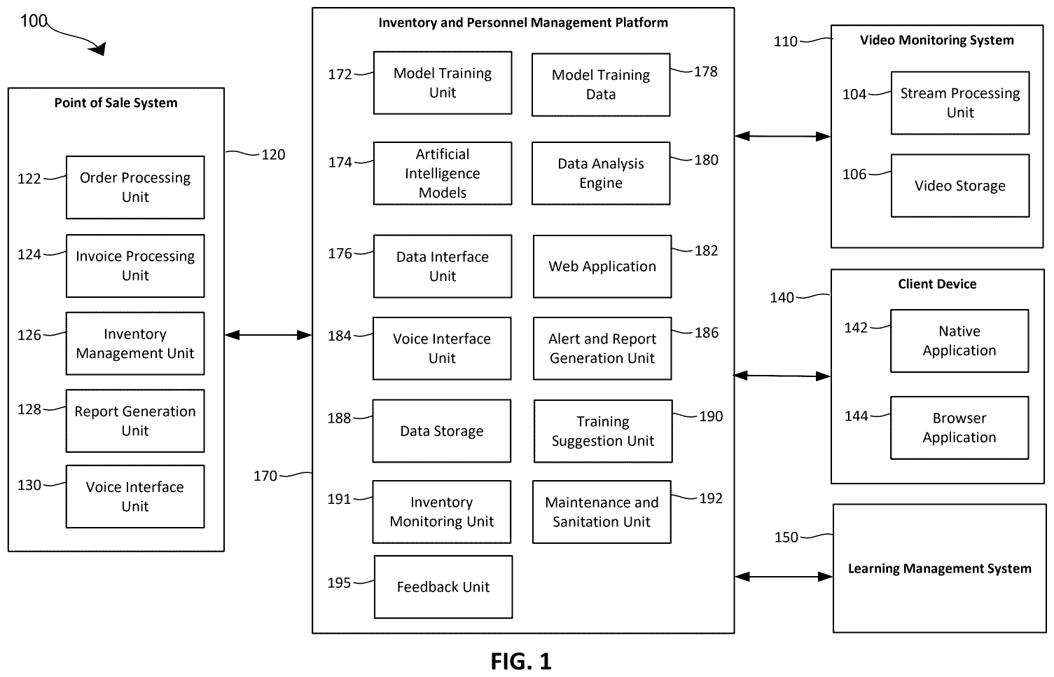

FIG. 1 is a diagram showing an example computing environment 100 in which the techniques disclosed herein for AI driven inventory and personnel management is implemented. The computing environment 100 includes an inventory and personnel management platform 170, a point of sale (POS) system 120, a video monitoring system 110, a learning management system (LMS) 150, and a client device 140. The POS system 120 communicates with the inventory and personnel management platform 170 via a network connection (not shown). The video monitoring system 110 also communicates with the inventory and personnel management platform 170 via a network connection (not shown). In the example implementation shown in FIG. 1, the inventory and personnel management platform 170 is implemented as a cloud-based service or set of services. However, in other implementations, the inventory and personnel management platform 170 can be implemented on a server of a local network or in an implementation of the POS system 120.

The video monitoring system 110 includes a stream processing unit 104 and video storage 106. The video monitoring system 110 is configured to receive video streams captured by cameras disposed throughout a restaurant or drinking establishment. The video cameras can be placed such that one or more cameras are enabled to capture the bar and surrounding area to enable the video monitoring system 110 to capture the actions taken by the bartender as the bartender makes drinks and performs other actions associated with operating the bar. The bar can be located in a drinking establishment, food service establishment, hospitality establishment, casino, and/or other retail establishments. The video monitoring system 110 can be connected with the video cameras via wired and/or wireless connections. The video cameras also have a sufficient resolution that the inventory and personnel management platform 170 can analyze video streams captured by these cameras to identify the bartender on duty, identify the spirits and/or other ingredients utilized by the bartender when making drinks, and identify other actions performed by the bartender. The video cameras can also capture customers who are seated at the bar and/or the bar area that are served by the bartender. The stream processing unit 104 is configured to receive the video streams from the video cameras and to store the video streams in the video storage 106 and/or send received video streams to the inventory and personnel management platform 170 for analysis. In some implementations, the video monitoring system 110 is configured to send video streams from specific cameras, such as those from the bar area to the inventory and personnel management platform 170. All of the video streams can be stored in the video storage 106 or another storage device for reference purposes. The stored video streams can be used for security purposes to serve as a record of incidents occurring in an establishment and/or used to monitor employee work performance related to legitimate business interest of the establishment. The video monitoring system 110 can be implemented as a computing system implemented locally at the restaurant or drinking establishment or located remotely. Some implementations of the video monitoring system 110 are a cloud-based service or set of services that stores and/processes video streams received from video cameras over a network connection.

The POS system 120 includes an order processing unit 122, an invoice processing unit 124, an inventory management unit 126, a report generation unit 128, and a voice interface unit 130. The order processing unit 122 provides a user interface that enables a bartender or server to enter orders for drinks and/or food. The order processing unit 122 forwards drink orders to a POS terminal at the bar for drinks that are to be made by the bartender and food orders to a terminal or terminals at the kitchen. The bartender or kitchen staff can then create the ordered items. The invoice processing unit 124 can be used to generate a bill or invoice for the customers that itemizes the items that the customers have ordered and any associated taxes or fees that the customer may owe. The invoice processing unit 124 can generate physical copies of the invoice to present to customers and/or present an electronic copy of the receipt to the user on a portable POS terminal. The portable POS terminal can also process electronic payments and/or send electronic copies of the invoice and/or payment information.

The inventory management unit 126 of the POS system 120 tracks the inventory of ingredients for food and drinks that may be ordered. The POS system 120 can prevent orders from being entered for drinks or food items which require ingredients that have been depleted. The inventory management unit 126 provides a user interface that enables a manager to order items from suppliers. The inventory management unit 126 enables the manager to set up or modify standing orders with suppliers requesting that the supplier regularly deliver specific products periodically to ensure that the establishment has sufficient supply of inventory items.

The report generation unit 128 generates various types of reports from data associated with the POS system 120. These reports can include but are not limited to sales reports identifying drinks and/or food items sold. These reports can also include inventory reports that provide an indication of the inventory items available, the projected rate at which these inventory items are likely to be depleted based on sales projections, costs associated with purchasing additional inventory, and/or other inventory related information. The report generation unit 128 provides a set of report templates for generating reports typically used by drinking and/or food service establishments. The report generation unit 128 can also include a user interface that enables managers to create custom reports from the sales and/or inventory information.

The voice interface unit 130 provides a voice interface that enables users to provide voice commands to the POS system 120 via POS terminal or POS device. The voice interface unit 130 can receive voice commands captured by the device and analyze these commands using a voice-to-text language model. The voice-to-text language model converts the voice input to text, and the voice interface unit 130 analyzes the text to determine whether the user has issued any commands to be performed by the POS system 120. For instance, the user may speak an order to the POS terminal and/or modify an existing order by speaking to the POS terminal. The voice interface unit 130 can be configured to support other types of commands as well. A technical benefit of this approach is that it provides a hands-free means for entering orders in which a bartender or member of the waitstaff can speak an order without having to navigate a complex user interface.

The inventory and personnel management platform 170 includes a model training unit 172, model training data 178, artificial intelligence (AI) models 174, data analysis engine 180, data interface unit 176, web application 182, voice interface unit 184, alert and report generation unit 186, data store 188, training suggestion unit 190, inventory monitoring unit 191, maintenance and sanitation unit 192, and feedback unit 195.

The inventory and personnel management platform 170 utilizes one or more AI models 174. These models can include a video analysis model trained to analyze video streams captured by the video monitoring system 110. The video analysis model is trained to analyze the video streams to monitor the performance of the bartender operating the bar and to output performance information indicative of the performance of the bartender during the video stream. The performance information indicates whether the bartender's actions satisfy various performance criteria, which may include but is not limited to meeting fulfillment goals for making drinks that have been ordered, balancing orders from waitstaff serving customers with orders from customers seated at the bar who are being served directly by the bartender, the number of drinks poured versus the number of drinks billed, time to greet customers at the bar, performance of pre-shift and post-shift duties, guest interactions, and/or other such criteria. In some implementations, the video analysis model is a multimodal model that is trained to receive video streams and invoice information as an input and to identify discrepancies between the drinks made by the bartender and the drinks ordered. The invoice information includes drinks that have been input by the bartender or waitstaff into the POS system 120. The multimodal model outputs incident information. The incident information can include information identifying the bartender who made the drinks, ingredients used to make the drinks, and/or discrepancies between the drinks made by the bartender and the drinks ordered. The discrepancy information can include a brand name or other identifier of the spirit or spirits that should have been included in the drink prepared by the bartender, the brand name or other identifier of the spirts or spirits that were actually included in the drink, the other ingredients included in the drink that were not included in the recipe for the drink and/or ingredients omitted from the drink that were included in the recipe. Another type of discrepancy occurs when the bartender adds more of a particular spirit than is called for by a recipe for a drink. The multimodal model analyzes the video stream content to determine a pour length indicative of how much of a spirit was added to a drink and indicates that a discrepancy occurs if the pour length exceeds an expected pour length by a threshold value. Overpouring can quickly add up over time and result in significant financial losses by the establishment. Another type of discrepancy that the multimodal can detect if fulfilment time representing how long it takes the bartender to make a drink after the drink order has been entered into the POS system 120. The multimodal model can analyze the invoice information and the video stream content to determine how much time has elapsed between the order for the drink being entered into the POS system 120 and the drink being prepared by the bartender and whether this discrepancy exceeds a fulfillment threshold. Yet another type of discrepancy that the video analysis model can detects is whether a drink has been served in the correct glassware, with the correct ingredients and garnish or garnishes, with the correct amount of ingredients and garnishes, with a stir stick, napkin, and/or coaster. The video analysis model can be trained to recognize these attributes of the drinks that have been prepared and served to ensure that the drinks are being prepared and presented correctly. As discussed in detail in the examples which follow, this discrepancy information can be used to generate alerts and/or reports in substantially real time as the bartender is operating the bar.

The model training unit 172 utilizes the model training data 178 to train the video analysis model and/or other models of the AI models 174. The model training data 178 includes labeled data used to train the video analysis model to recognize bottles of spirits and/or other bottled ingredients so that the model can determine which ingredients the bartender included in drinks being prepared. The training data can include views of the bottles from multiple angles and/or partially obscured to enable the model to be able to analyze video streams of the bartender preparing drinks and predict which spirits or other ingredients the bartender used in preparing the drinks. The training data can include labeled images and/or videos that feature the spirits and/or other items that the model is supposed to be trained to recognize. The training data can also include the labeled images of the drink being presented on one or more preferred glassware options. The training data can also include examples of the drinks with the correct garnishes added. The model training data 178 can also include validation data, which is another set of labeled data that is used by the model training unit 172 to determine whether the trained video analysis model is correctly predicting which ingredients the bartender included in a drink. Additional training data can be added to the model training data 178 as new items are added to the bar inventory and/or the label or bottle of an item is modified by the manufacturer.

The feedback unit 195 provides a means for users to provide feedback on the alerts, reports, and/or training recommendations generated by the AI models 174. The native application 114 and/or the web application 182 provide a feedback user interface in some implementations in which an authorized user, such as but not limited to a manager, can select alert, report, and/or training recommendations that have been generated by the AI models 174 and provide feedback indicative of errors in the alert, report, and/or training recommendations. The user can provide feedback that an issue has been incorrectly identified. The feedback user interface can also enable the user to provide feedback that a customer or staff member has been incorrectly identified either in an alert, report, or training recommendation or in the information provided to the POS system 120. The user can provide an indication that the system incorrectly identified a customer or staff member and can provide a correct identity for the incorrectly identified customer or staff member. The feedback unit 195 also provides means for users to provide feedback for calibrating which issues should be reported in real-time and which issues can be reported in a report that can be handled at later time. The feedback unit 195 can provide a user interface that enables an authorized user to select alerts and/or reports that have been generated by the system and to provide feedback indicating whether the issues included thereon should have been reported in real time or in a summary report for handling later. This feedback can be used by the feedback unit 195 to fine tune the training of the AI models 174 correctly handle generating of alerts, reports, and/or training request for specific issues in real time or for handling later.

The user interface enables the user to input feedback that describes the error that occurred. The user interface also enables the user to view imagery and/or video content associated with the alert, report, or training request or the misidentification of the customer or member of staff. In some implementations, the user interface of the feedback unit 195 can present a set of predetermined questions that help guide the user to input information regarding the incorrect identification that can be provided to the model training unit 172 to generate training data that correctly labels the imagery and/or videos that were misclassified by the video analysis model and/or other models of the AI models 174. The new training data is stored in the model training data 178 and is used by the model training unit 172 to fine-tune the training of the model or models that misclassified the imagery and/or video content.

The AI models 174 can include additional models, such as a generative language model that is configured to generate alerts, reports, and/or training recommendations based on the performance information and/or incident information generated by the video analysis model as discussed above. The generative language model can include but is not limited to a Generative Pre-trained Transformer model, such as GPT-4. Other such generative language models can also be utilized by the inventory and personnel management platform 170. The generative language models may be implemented on the inventory and personnel management platform 170 or implemented by a remote server that is accessible over a network connection. In such implementations, the data analysis engine 180 is configured to construct a prompt to the generative language model to cause the generative language to generate the text of the alerts, reports, and/or training recommendations based on the performance information and/or incident information. The data analysis engine 180 can construct the prompts using prompt templates to ensure that the instructions to the generative model are consistent.

The data interface unit 176 provides received information from the POS system 120 and/or the video monitoring system 110 and formats this data to consistent predetermined formats utilized by the inventory and personnel management platform 170. A technical benefit of this approach is that the inventory and personnel management platform 170 can interact with various types of POS systems and/or video monitoring systems without requiring that the POS systems and/or the video monitoring systems be customized for use with the inventory and personnel management platform 170. For example, the data interface unit 176 can format invoice information received from the POS system 120 and/or video streams received from the video monitoring system 110. The data interface unit 176 can store the standardized data in the data store 188, which is a persistent datastore in the memory of the inventory and personnel management platform 170. The data interface unit 176 can also provide the standardized data to the data analysis engine 180 for processing.

The data analysis engine 180 analyzes invoice information for drink orders entered in the POS system 120 and one or more video streams of the bartender preparing drinks captured by cameras associated with the video monitoring system 110. The data analysis engine 180 provides the invoice information and/or the one or more video streams of the bartender preparing drinks to the video analysis model of the AI models 174. The video monitoring system 110 may be associated with multiple cameras that provide different views of the bartender making drinks and/or performing other actions. The data analysis engine 180 can provide each of these video streams to the video analysis model. Some implementations of the video analysis model are capable of receiving and analyzing multiple video content streams simultaneously, while other implementations analyze the video content streams separately. In implementations where multiple streams are analyzed separately, the data analysis engine 180 can correlate the predictions output by the video analysis model when analyzing the individual streams when determining whether there were any performance issues and/or discrepancies between the drinks prepared by the bartender and the drinks invoiced via the POS system 120. A technical benefit of this approach is that when the view from a camera is partially obscured, making it difficult to determine whether there were any performance issues or discrepancies, but the view of another camera is able to more clearly capture the actions taken by the bartender, data from multiple video streams can be corelated to provide a more accurate analysis. The data analysis engine 180 provides performance information and/or discrepancy information generated by the video analysis model and/or generated by the data analysis engine 180 by corelating data from multiple video streams to the alert and report generation unit 186 and/or the training suggestion unit 190. The data analysis engine 180 processes the invoice information and/or the video content streams in substantially real time, and thus, provides the performance information and/or discrepancy information to the alert and report generation unit 186 and/or the training suggestion unit 190 in substantially real time. Consequently, the inventory and personnel management platform 170 can monitor sales and drinks being made in substantially real time and generate reports and/or alerts for a manager so that action can be taken quickly to reduce the likelihood of substantial loss of revenue.

The alert and report generation unit 186 analyzes the performance information and/or discrepancy information generated by a video analysis model and generates alerts to a manager or managers and/or to the bartender regarding performance issues and/or discrepancies between drinks invoiced and/or drinks made. These alerts and/or reports can be generated in substantially real time as issues are detected by the inventory and personnel management platform 170. The alerts can include text messages, emails, or other types of messages to a manager that can be received on a mobile phone, tablet, a portable POS terminal, or other types of mobile computing device that can be carried or worn by the manager on duty. The alerts notify the manager of issues with the bartender's performance that could negatively impact customer satisfaction and/or the establishment's revenue. The manager can follow up on these issues as they are occurring or shortly thereafter to ensure that issues do not continue to impact the operations of the bar. Alerts typically include single issues that are identified by the inventory and personnel management platform 170, while reports may include a summary of multiple issues and/or provide additional details related to alerts that have been generated. The inventory and personnel management platform 170 stores the alerts in the data store 188 and/or reports and provides a user interface for the managers to view alerts and or reports that have been created by the alert and report generation unit 186.

The training suggestion unit 190 analyzes the performance information and/or discrepancy information generated by the video analysis model and suggests training content to present to the bartender that may help improve their performance. The training content is managed by the LMS 150 in some implementations. The training content can include various types of training, such as but not limited content related to customer service, streamlining processes to help improve drink fulfillment times, avoiding waste, and the impact on the budget of the establishment caused by providing non-revenue drinks to customers. The training content can be developed for various topics, labeled, and stored on the inventory and personnel management platform 170 and/or on the LMS 150. Some implementations rely on external training content sources, such as the LMS 150, and provide a link to the external content. The training suggestion unit 190 and/or the LMS 150 can also generate a performance improvement plan for the bartender that is shared with the bartender and their manager. The performance improvement plan can include various milestones to be achieved to improve the performance of the bartender. The training suggestion unit 190 and/or the LMS 150 can track these milestones and notify the manager as these milestones are completed. For instance, these milestones can include completion of specific training tasks and/or performing certain actions. The training suggestion unit 190 and/or the LMS 150 can also generate daily, weekly, monthly, and/or annual summaries of the training recommendations that have been made to members of staff and provide these summaries of to the members of staff and/or their respective managers. The training summary can include information indicating the recommended training that has been completed and the training that has yet to be completed.

The voice interface unit 184 provides a voice interface that enables users to provide voice commands to the inventory and personnel management platform 170 via a portable POS device or client device 140. The voice interface unit 184 can receive voice commands captured by the device and analyze these commands using a voice-to-text language model implemented by the AI models 174. The voice-to-text language model converts the voice input to text, and the voice interface unit 184 analyzes the text to determine whether the user has issued any commands to be performed by the inventory and personnel management platform 170. For instance, the user may enter a spoken command to view details of an alert. The voice interface unit 184 can be configured to support other types of commands as well. The POS system 120 also includes a touchscreen, keypad, and/or other type of tactile interface that enables bartenders and/or other staff members to

The inventory monitoring unit 191 outputs supply information identifying the ingredients and/or other supplies utilized in preparing drinks, snacks, and/or other food items to customers. The supply information is not limited by the recipe information and/or invoice information obtained from the POS system 120. Instead, the supply information indicates the actual inventory items that were utilized by the bartender. These supplies can include alcoholic and/or non-alcoholic drinks, garnishes used on drinks, stir sticks and/or straws, napkins, coasters, and/or other inventory items that are used to prepare and/or serve drinks. The supplies can also include drinkware and/or other serving ware that is detected as being discarded due to breakage by either the bartender, other staff members, or by customers.

The inventory monitoring unit 191 utilizes one or more video analysis models to analyze the video streams obtained from the video monitoring system 110. These video analysis models can be the same models as those discussed above or can be video analysis models trained to recognize inventory items and/or the utilization thereof by the bartender, other staff, and/or customers. The one or more video analysis models identify inventory items that have been utilized. The inventory monitoring unit 191 interfaces with the inventory management unit 126 of the POS system 120 via the data interface unit 176 to notify the inventory management unit 126 of the inventory items that have been utilized. The inventory management unit 126 can then facilitate reordering of these items as necessary. While the inventory management is performed at least in part by the POS system 120 shown in the example implement of FIG. 1, other implementations of the inventory and personnel management platform 170 implement the inventory management functionality of the inventory management unit 126.

The maintenance and sanitation unit 192 utilizes one or more video analysis models to analyze the video streams obtained from the video monitoring system 110 to detect maintenance and/or sanitation issues in the bar area that can negatively impact the customer experience and/or result in health code violations that could lead to illness and/or sanctions by regulatory bodies tasked with ensuring that the bar, restaurant, casino, and/or retail establishment is being operated according to local sanitary requirements. The maintenance and sanitation unit 192 utilizes one or more video analysis models to analyze the video streams obtained from the video monitoring system 110 to identify potential issues. These models can be the same video analysis models as those discussed in the preceding examples or can be specifically trained to recognize maintenance and/or sanitation issues. In a non-limiting example, the maintenance and sanitation unit 192 can identify sanitation issues, such as but not limited to maintaining a cluttered work area, failure regularly empty trash receptacles, failure to adequately wash glassware and/or other serveware, failure to adequately sanitize surfaces in the bar area, and/or failure to remove dirty glasses and/or other serveware from the bar and/or customer tables within a threshold period of time. In another non-limiting example, the maintenance and sanitation unit 192 can identify maintenance issues, such as but not limited to broken or insufficient lighting, broken or damaged fixtures or furniture, broken or unavailable sanitation stations for the bartender and/or other staff to wash their hands, and/or other maintenance issues that can cause a safety hazard for the bartender, other staff, and/or customers.

The client device 140 is a computing device that can be used to view reports and/or alerts generated by the inventory and personnel management platform 170. The client device 140 can be used by a manager of a drinking or food service establishment to view the alerts generated by the inventory and personnel management platform 170. The client device 140 may alternatively be used by a bartender to view alerts and/or reports generated by the inventory and personnel management platform 170. The client device 140 can also be used by the bartender to view and/or participate in training suggested by the inventory and personnel management platform 170.

The client device 140 can be implemented as a portable electronic device, such as a mobile phone, a tablet computer, a laptop computer, a portable digital assistant device, and/or other such devices. The client device 140 may also be implemented in computing devices having other form factors, such as a desktop computer and/or other types of computing devices. In some implementations, the functionality of the client device 140 is implemented by the POS system 120. While the example implementation shown in FIG. 1 includes just one client device, other implementations may include a different number of client devices that utilize the inventory and personnel management platform 170.

The client device 140 includes a native application 142 and a browser application 144 in the example implementation shown in FIG. 1. Other implementations may include one or other of these applications. The browser application 144 is an application for accessing and viewing web-based content, the web-based content may be provided by the inventory and personnel management platform 170. The inventory and personnel management platform 170 provides the web application 182 that enables users to view alerts, reports, and/or training content in some implementations. A user of the client device 140 may access the web application 182 via the browser application 144, and the browser application 144 renders a user interface for interacting with the inventory and personnel management platform 170 in the browser application 144. The native application 142 is a web-enabled application that is capable of rendering content such as alerts, reports, video content, and/or training content obtained from inventory and personnel management platform 170.

The LMS 150 is a platform for creating, managing, and delivering training content. The LMS 150 can store various types of training course content that can be consumed online. The training course content can include video content, slide presentations, and/or textual content that can be used to train members of staff. The LMS 150 generates training plans for members of staff based on performance issues identified by inventory and personnel management platform 170, tracks the completion of the recommended training included in the training plan, and/or tracks whether the performance issues that triggered the training suggestion unit 190 and/or the LMS 150 to recommend the training plan have been remedied or further training may be required. The LMS 150 provides a web-based interface that that members of staff can utilize to access and complete the training recommended in their respective training plans. The LMS 150 also provides a user interface for managers, owners, and/or other authorized users to design training plans for responding to the types of performance issues that can be identified by the training suggestion unit 190. The training plans may include content that has been provided by the LMS 150 and/or establishment-specific content that has been generated by or for the establishment and is maintained on the LMS 150. The training plan recommendations can be updated periodically in response to the training suggestion unit 190 being updated to identify additional types of performance issues that can occur at the establishment. The training course content can include mandatory training that is required in response to a threshold number of errors in performance of specified tasks. This threshold can be configured for each type of tasks. Some examples of the types of tasks can include but are not limited to speed of delivery of food and/or drinks to the customer, pour accuracy for alcoholic drinks, use of correct non-alcoholic ingredients, correct glassware, and/or garnishes for drinks, amount of time to greet customers, performance of pre-shift and/or post-shift duties, performance of proper check in and check out procedures, performing check in in front of customers seated at bar, and/or guest interactions. The LMS 150 can also analyze the tip amounts that the bartender and/or members of staff receive to provide feedback why certain bartenders and/or other members of staff receive more tips than others.

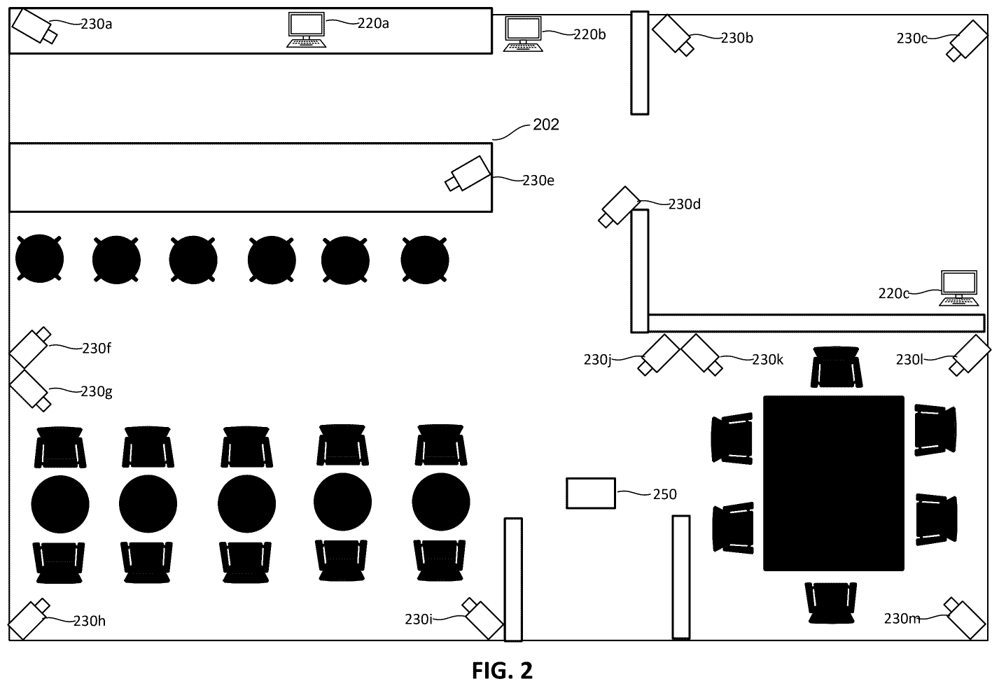

FIG. 2 is a diagram showing a non-limiting example layout of a restaurant in which the techniques herein have been implemented shown in FIG. 1. The restaurant includes a bar 202 with bar stools that provide seating at the bar. The restaurant also has tables and chairs for customers disposed throughout the restaurant. The cameras 230a-230m are disposed throughout the restaurant and provide video streams of their respective fields of view to the video monitoring system 110. The POS terminals 220a and 220b enable the bartenders and/or waitstaff to enter orders for drinks and/or food. The POS terminal 220c is disposed in the kitchen and enables the kitchen staff to view and prepare food orders. The host station 250 can also include a POS terminal (not shown) that enables a host or hostess to view able seating, to access and/or make reservations, and/or add walk-in customers to a wait list.

The cameras 230a, 230e, and 230f have views of the bar area. The video streams from these cameras can be analyzed by the inventory and personnel management platform 170 to monitor the bartender or waitstaff placing orders for food and/or drinks and the bartender making drinks. As discussed in the preceding examples, the inventory and personnel management platform 170 analyzes these video streams to determine performance information indicative of the performance of the bartender's various tasks and/or discrepancy information indicative of discrepancies between the drinks made by the bartender and the drinks ordered. The discrepancy information can identify the bartender who made the drinks, ingredients used to make the drinks, and discrepancies between the drinks made by the bartender and the drinks ordered by customers. This information can be used to identify waste that impacts revenue due to spilled drinks, drinks being provided without charge to customers, drinks being upgraded with more expensive ingredients than drinks actually ordered and paid for by customers, drinks being made incorrectly and/or returned by the customers or waitstaff, and/or other such actions that can result in significant losses in revenue for the establishment. The inventory and personnel management platform 170 analyzes video content in substantially real time. Consequently, the inventory and personnel management platform 170 can identify these issues as they are occurring or shortly thereafter and alert manager so that action can be taken rapidly to prevent further losses. As discussed above, the inventory and personnel management platform 170 can also make training recommendations for addressing problematic behavior and improving bartender performance. Furthermore, the inventory and personnel management platform 170 can also be used to highlight bartenders who are performing well so that the management can reward these valuable members of the staff. Using the inventory and personnel management platform 170 to determine employee performance provides an objective measurement of employee performance.

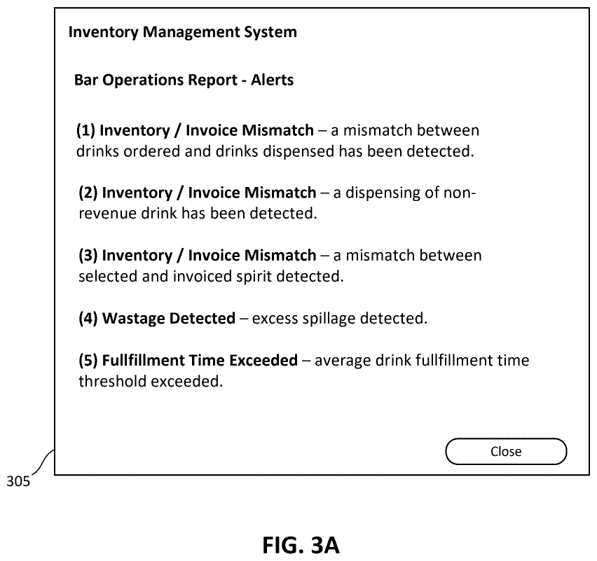

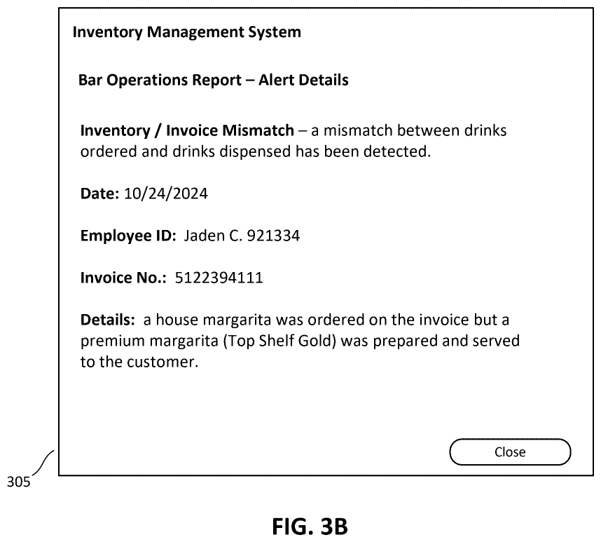

FIGS. 3A and 3B are diagrams of an example user interface 305 of an alerts and reporting application according to the techniques disclosed herein. The alerts and reporting application can be implemented by the native application 142 on a client device 140 or on a POS terminal associated with the POS system 120. The alerts are generated by the alert and report generation unit 186 of the inventory and personnel management platform 170. FIG. 3B shows details of one of the alerts from the list of alerts shown in FIG. 3A. The user can click on or otherwise select one of the alerts from the list shown in FIG. 3A to cause the details of that alert to be presented.

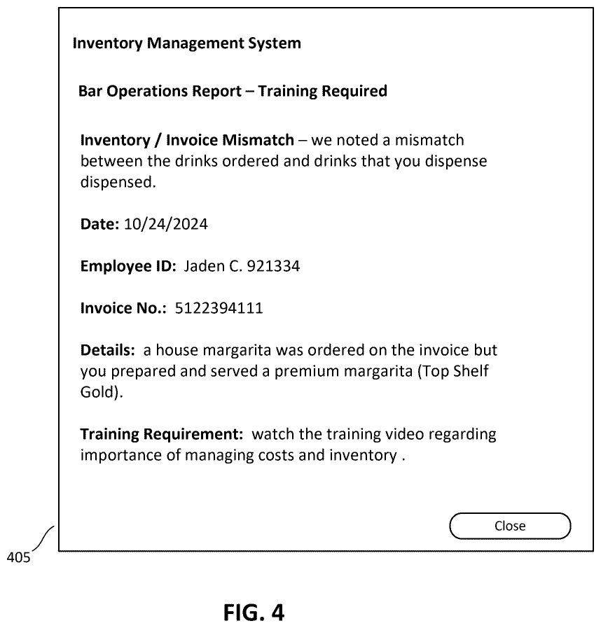

FIG. 4 is a diagram providing an example of a user interface 405 of an alerts and reporting application according to the techniques disclosed herein. The user interface 405 presents training suggestions determined by the training suggestion unit 190 of the inventory and personnel management platform 170. The training data suggestions can be sent to both the bartender and the manager, so that the manager is aware of the suggested training.

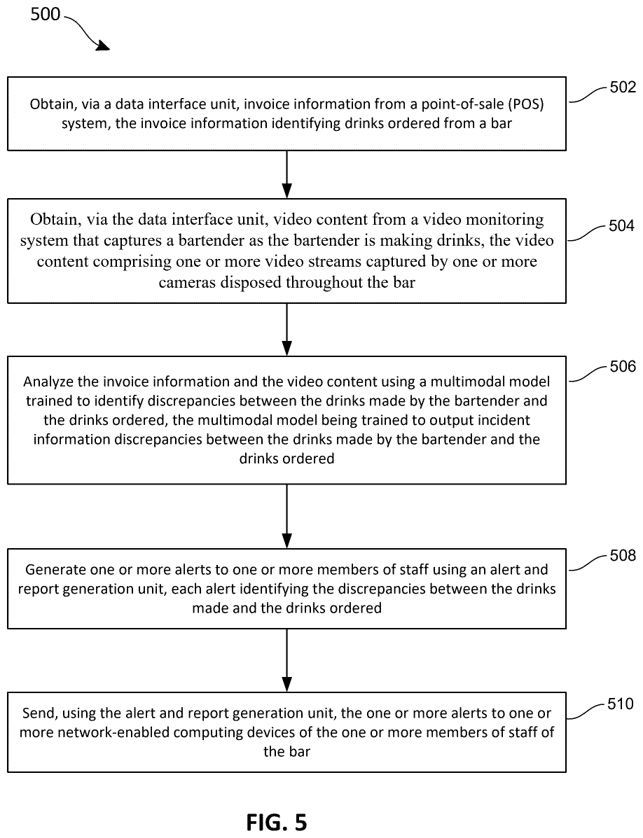

FIG. 5 is an example flow chart of an example process 500 for managing inventory and personnel according to the techniques described herein. The process 500 can be implemented by the inventory and personnel management platform 170 discussed in the preceding examples.

The process 500 includes an operation 502 of obtaining, via a data interface unit, invoice information from a point-of-sale (POS) system. The invoice information identifies drinks ordered from the bar. As discussed in the preceding examples, the bartender or waitstaff can enter drink orders into the POS system 120.

The process 500 includes an operation 504 of obtaining, via the data interface unit, video content from a video monitoring system that captures a bartender as the bartender is making drinks. The video content includes one or more video streams captured by one or more cameras disposed throughout the bar. The inventory and personnel management platform 170 obtains video streams from one or more video cameras from the video monitoring system 110.

The process 500 includes an operation 506 of analyzing the invoice information and the video content using a multimodal model trained to identify discrepancies between the drinks made by the bartender and the drinks ordered. The multimodal model is trained to output incident information identifying discrepancies between the drinks made by the bartender and the drinks ordered. The discrepancy information can also include information identifying the bartender who made the drinks and/or ingredients used to make the drinks. The video analysis model of the AI models 174 can be a multimodal model that can analyze multiple sources of information, such as but not limited to one or more video content streams, invoice information, and/or recipe information for drinks that have been ordered.

The process 500 includes an operation 508 of generating one or more alerts to one or more members of staff using an alert and report generation unit, each alert identifying the discrepancies between the drinks made and the drinks ordered and an operation 510 of sending, using the alert and report generation unit, the one or more alerts to one or more network-enabled computing devices of the one or more members of staff of the bar. The inventory and personnel management platform 170 analyzes the various information discussed above in substantially real time to identify issues such as discrepancies between the drinks that the bartender is making compared to what was ordered via the POS system 120. A technical benefit of this approach is that the inventory and personnel management platform 170 can identify issues that can cause losses in revenue as these incidents are occurring or shortly thereafter to enable a manager to address these problems and stop further financial losses.

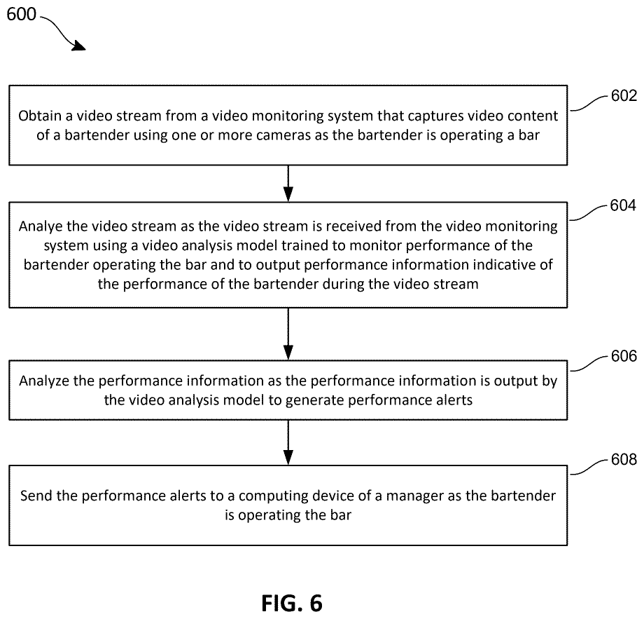

FIG. 6 is an example flow chart of an example process 600 for managing inventory and personnel according to the techniques described herein. The process 600 can be implemented by the inventory and personnel management platform 170 discussed in the preceding examples.

The process 600 includes an operation 602 of obtaining a video stream from a video monitoring system that captures video content of a bartender using one or more cameras as the bartender is operating a bar. The inventory and personnel management platform 170 obtains video streams from one or more video cameras from the video monitoring system 110.

The process 600 includes an operation 604 of analyzing the video stream as the video stream is received from the video monitoring system using a video analysis model trained to monitor performance of the bartender operating the bar and to output performance information indicative of the performance of the bartender during the video stream. As discussed in the preceding examples, the video analysis model can be trained to analyze the video streams to identify various actions taken by the bartender that reflect the performance of the bartender.

The process 600 includes an operation 606 of analyzing the performance information as the performance information is output by the video analysis model to generate performance alerts and an operation 608 of sending the performance alerts to a computing device of a manager as the bartender is operating the bar. The alert and report generation unit 186 of the inventory and personnel management platform 170 analyzes the performance information to determine whether there are any issues with the performance of the bartender that need to be addressed quickly to avoid loss of revenue and/or to improve the customer experience. These alerts inform the manager of issues that need to be address, such as but not limited the bartender making drinks incorrectly, not charging customers for the drinks, taking too long to make drinks after the drink orders have been placed, and/or other issues that can result in a loss of revenue for the establishment and/or reduce customer satisfaction. A technical benefit of this approach is that the inventory and personnel management platform 170 analyzes the video streams monitoring the bartender in substantially real time and generates these alerts. A manager cannot constantly monitor the activity of every staff member at the restaurant and would be unlikely to detect such issues immediately. More likely, the manager would not be aware of such issues until the inventory and sales reports are generated indicating discrepancies between what was served and what was billed to customers or when customer complaints are received.

The detailed examples of systems, devices, and techniques described in connection with FIGS. 1-6 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-6 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

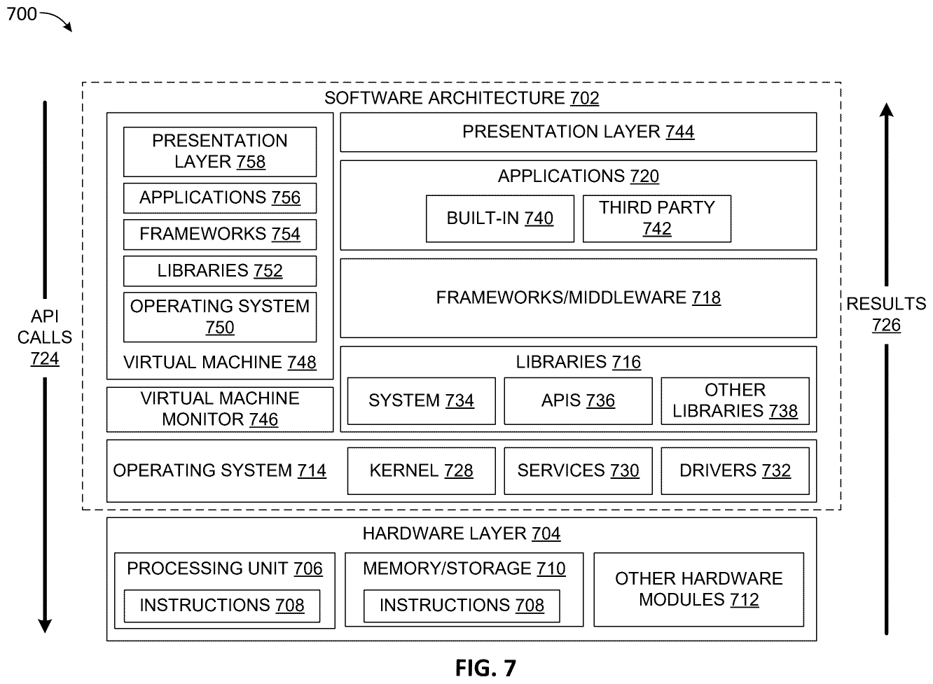

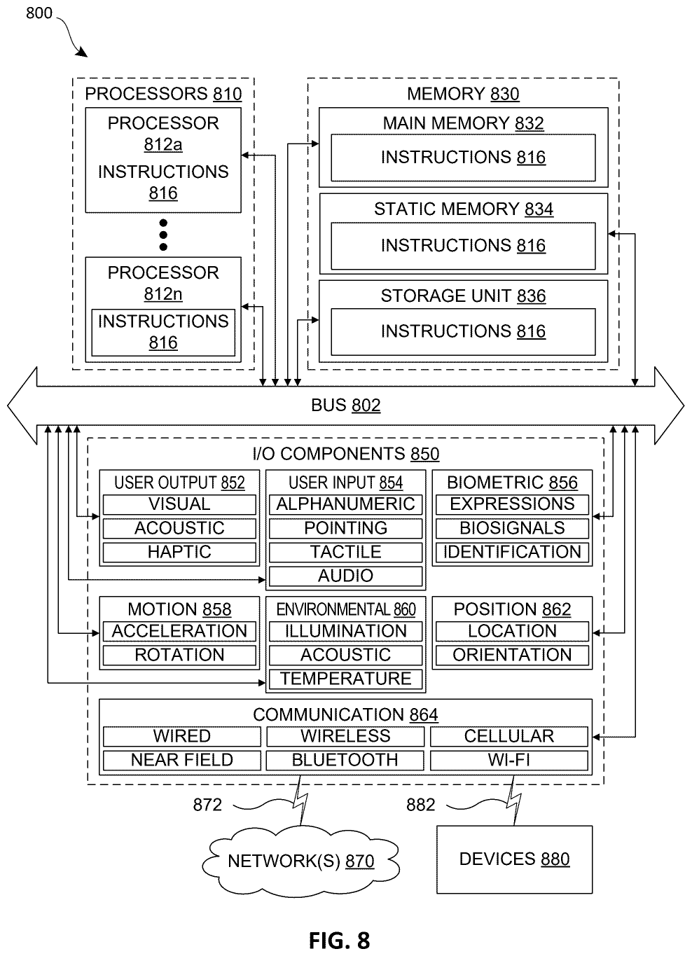

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory/storage 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks/middleware 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks/middleware 718 provide a higher-level common infrastructure that may be used by the applications 720 and/or other software modules. For example, the frameworks/middleware 718 may provide various graphic user interface (GUI) functions, high-level resource management, or high-level location services. The frameworks/middleware 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks/middleware 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory/storage 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory storing executable instructions that, when executed, cause the processor alone or in combination with other processors to perform operations of:
obtaining, via a data interface unit, invoice information from a point-of-sale (POS) system, the invoice information identifying drinks ordered from a bar;
obtaining, via the data interface unit, video content from a video monitoring system that captures a bartender as the bartender is making drinks, the video content comprising one or more video streams captured by one or more cameras disposed throughout the bar;
analyzing the invoice information and the video content using a multimodal model trained to identify discrepancies between the drinks made by the bartender and the drinks ordered, the multimodal model being trained to output incident information discrepancies between the drinks made by the bartender and the drinks ordered;
generating one or more alerts to one or more members of staff using an alert and report generation unit, each alert identifying the discrepancies between the drinks made and the drinks ordered; and
sending, using the alert and report generation unit, the one or more alerts to one or more network-enabled computing devices of the one or more members of staff of the bar.

2. The data processing system of claim 1, wherein the incident information includes information identifying the bartender who made the drinks and ingredients used to make the drinks.

3. The data processing system of claim 1, wherein analyzing the invoice information and the video content using the multimodal model further comprises:
identifying a spirit included a drink by identifying in the video content a bottle of the spirit from which the bartender poured the spirit.

4. The data processing system of claim 1, wherein analyzing the invoice information and the video content using the multimodal model further comprises:
analyzing the video content to determine a pour length indicative of how much of a spirit was added to a drink; and
determining that a discrepancy has occurred if the pour length exceeds an expected pour length by a threshold value.

5. The data processing system of claim 4, wherein analyzing the invoice information and the video content using the multimodal model further comprises:
obtaining recipe information indicating ingredients that should be included in a particular drink;
analyzing the video content to determine whether ingredients added to the drink deviate from ingredients identified in the recipe information; and
determining that a discrepancy has occurred if the ingredients added to the drink deviate from the recipe information.

6. The data processing system of claim 1, wherein analyzing the invoice information and the video content using the multimodal model further comprises:
determining an amount of time elapsed between an order for a drink being entered in the POS system and the drink being prepared by the bartender; and
determining that a discrepancy has occurred if the amount of time exceeds a fulfilment threshold.

7. The data processing system of claim 1, wherein analyzing the invoice information and the video content using the multimodal model further comprises:
determining that a drink prepared by the bartender was not included in the invoice information.

8. The data processing system of claim 1, wherein the memory further includes instructions configured to cause the processor alone or in combination with other processors to perform operations of:
generating a report comprising discrepancy information collected over a predetermined period of time; and
sending the report to a computing device of a manager of the bar.

9. The data processing system of claim 1, wherein the memory further includes instructions configured to cause the processor alone or in combination with other processors to perform operations of:
generating a training suggestion based on discrepancy information collected over a predetermined period of time; and
sending the training suggestion to a computing device of a bar tender of the bar.

10. A method implemented in a data processing system for operating an inventory and personnel management system, the method comprising:
obtaining, via a data interface unit, invoice information from a point-of-sale (POS) system, the invoice information identifying drinks ordered from a bar;
obtaining, via the data interface unit, video content from a video monitoring system that captures a bartender as the bartender is making drinks, the video content comprising one or more video streams captured by one or more cameras disposed throughout the bar;
analyzing the invoice information and the video content using a multimodal model trained to identify discrepancies between the drinks made by the bartender and the drinks ordered, the multimodal model being trained to output incident information discrepancies between the drinks made by the bartender and the drinks ordered;
generating one or more alerts to one or more members of staff using an alert and report generation unit, each alert identifying the discrepancies between the drinks made and the drinks ordered; and
sending, using the alert and report generation unit, the one or more alerts to one or more network-enabled computing devices of the one or more members of staff of the bar.

11. The method of claim 10, wherein analyzing the invoice information and the video content using the multimodal model further comprises:
identifying a spirit included a drink by identifying in the video content a bottle of the spirit from which the bartender poured the spirit.

12. The method of claim 10, wherein analyzing the invoice information and the video content using the multimodal model further comprises:
analyzing the video content to determine a pour length indicative of how much of a spirit was added to a drink; and
determining that a discrepancy has occurred if the pour length exceeds an expected pour length by a threshold value.

13. The method of claim 12, wherein analyzing the invoice information and the video content using the multimodal model further comprises:
obtaining recipe information indicating ingredients that should be included in a particular drink;
analyzing the video content to determine whether ingredients added to the drink deviate from ingredients identified in the recipe information; and
determining that a discrepancy has occurred if the ingredients added to the drink deviate from the recipe information.

14. A data processing system comprising:
a processor; and
a memory storing executable instructions that, when executed, cause the processor alone or in combination with other processors to perform operations of:
obtaining a video stream from a video monitoring system that captures video content of a bartender using one or more cameras as the bartender is operating a bar;
analyzing the video stream as the video stream is received from the video monitoring system using a video analysis model trained to monitor performance of the bartender operating the bar and to output performance information indicative of the performance of the bartender during the video stream;
analyzing the performance information as the performance information is output by the video analysis model to generate performance alerts; and
sending the performance alerts to a computing device of a manager as the bartender is operating the bar.

15. The data processing system of claim 14, wherein analyzing the video stream using the video analysis model further comprises:
identifying a spirit included a drink by identifying in the video content a bottle of the spirit from which the bartender poured the spirit.

16. The data processing system of claim 14, wherein analyzing the video stream using the video analysis model further comprises:
analyzing the video content to determine a pour length indicative of how much of a spirit was added to a drink; and
determining that a discrepancy has occurred if the pour length exceeds an expected pour length by a threshold value.

17. The data processing system of claim 16, wherein analyzing the video stream using the video analysis model further comprises:
obtaining recipe information indicating ingredients that should be included in a particular drink;
analyzing the video content to determine whether ingredients added to the drink deviate from ingredients identified in the recipe information; and
determining that a discrepancy has occurred if the ingredients added to the drink deviate from the recipe information.

18. The data processing system of claim 14, wherein the memory further includes instructions configured to cause the processor alone or in combination with other processors to perform operations of:
obtaining invoice information from a point-of-sale (POS) system associated with the bar, the invoice information identifying drinks ordered from the bar;
wherein the video analysis model is a multimodal model configured to receive the video stream and invoice information as an input.

19. The data processing system of claim 18, wherein the memory further includes instructions configured to cause the processor alone or in combination with other processors to perform operations of:
determining an amount of time elapsed between an order for a drink being entered in the POS system and the drink being prepared by the bartender; and
determining that a discrepancy has occurred if the amount of time exceeds a fulfilment threshold.

20. The data processing system of claim 18, wherein the memory further includes instructions configured to cause the processor alone or in combination with other processors to perform operations of:
determining that a drink prepared by the bartender was not included in the invoice information.
